(19) United States
(12) Patent Application Publication
(10) Pub. No.: US 2010/0150487 A1
(43) Pub. Date: Jun. 17, 2010

(54) Bearing assembly

(75) Inventors: Thilo Beck, Werneck (DE); Rico Dittmar, Schweinfurt (DE); Gerhard Haas, Dittelbrunn (DE); Bernd Stephan, Schweinfurt (DE); Arno Stubenrauch, Aidhausen (DE); Peter Volpert, Bergrheinfeld (DE); Thomas Will, Schweinfurt (DE); Anastazi Sarigiannis, Livonia, MI (US)

Correspondence Address: Mark A. Ussai;SKF USA Inc., 1111 Adams Avenue, Norristown, PA, 19403, US

(73) Assignee: Aktiebolaget SKF, Goteborg (SE)

(21) Appl. No.: 12/384,704

(22) Filed: Apr. 8, 2009

(30) Foreign Application Priority Data
Dec. 17, 2008 (DE) 10 2008 062 740.2

(51) Int. Cl. F16C 19/50; F16C 13/00

(52) U.S. Cl. 384/494; 384/544

(57) ABSTRACT

A bearing assembly comprises at least two axially-spaced bearings, each bearing including an inner ring. The at least two inner rings have differently-sized bore diameters. A sleeve-shaped connecting piece having a substantially frustum, conical or tapered shape is disposed between the two inner rings. An inner diameter of the connecting piece at its respective axial end regions corresponds to the respective bore diameter of the bordering inner ring so that first and second contact points are defined between the connecting piece and the respective inner rings. First and second curved or ring-shaped fixing elements are respectively disposed at the first and second contact points so as to fix the inner rings relative to the connecting piece in the radial direction of the bearing assembly. Each fixing element at least partially axially overlaps the connecting piece and the respective inner ring.

### CROSS-REFERENCE

This application claims priority to German patent application no. 10 2008 062 740.2, filed on Dec. 17, 2008, which is incorporated fully herein by reference.

### TECHNICAL FIELD

The present invention generally relates to bearings and bearing assemblies, which may preferably be utilized in wheel bearings, e.g., truck wheel bearings, in certain applications of the present teachings.

### BACKGROUND ART

Some known bearing assemblies for wheel bearings utilized in trucks comprise two inner rings or races having different bore diameters. A frustum-shaped connecting piece or spacer is disposed between the differently-sized inner rings and serves to set the spacing of the inner rings in the axial direction. The inner rings and spacer are mounted on a non-driven wheel axle or axle spindle having an outer shape that generally corresponds to the shape of the inner bores of the inner rings and spacer. Roller elements are disposed between the inner rings, which contact the axle spindle and do not rotate during driving, and a corresponding set of outer rings or races, thereby forming inboard and outboard roller bearings. These roller bearings enable a wheel hub coupled to a wheel to rotate about the non-driven axle spindle when the vehicle is driven.

To simplify mounting of the wheel mount on the wheel axle, the inner ring having the smaller diameter is disposed, with respect to the insertion direction of the wheel axle, on the forward or front side of the wheel mount and the inner ring having the larger diameter is disposed on the rearward side of the wheel mount. The circumferences of the wheel axle or axle spindle correspond to the bore diameters of the inner rings and the spacer, such that, during mounting of the wheel mount on the wheel axle, the segment of smaller circumference is initially guided through the larger-diameter inner ring and the spacer. This wheel mounting procedure can thus be performed in a relatively simple manner. As soon as the axle spindle segment having the smaller circumference is completely inserted into the inner ring having the smaller diameter, the frustum-shaped segment of the axle spindle is located in the corresponding frustum-shaped segment of the spacer and the segment of the axle spindle having the larger circumference is located in the inner ring having the larger diameter.

In such a three-part construction, axial shifting or displacement of the inner rings relative to the spacer may not be sufficiently restricted or prevented during the mounting procedure. Further, if the junction of the respective inner rings and the spacer is not relatively smooth, the axle spindle could bump against the spacer or the smaller inner ring during insertion into the wheel bearing assembly, which would hinder the wheel mounting procedure.

### SUMMARY

It is an object of the present invention to provide an improved bearing and/or bearing assembly.

According to a first aspect of the present teachings, a bearing assembly preferably comprises at least two axially-spaced bearings. Each bearing comprises an inner ring and the two inner rings have preferably differently-sized bore diameters. A substantially sleeve-shaped connecting piece is disposed between the two inner rings and preferably at least substantially defines the axial separation or spacing between the two inner rings. The sleeve or connecting piece may preferably have a substantially frustum, conical or tapered shape. The inner diameter at each axial end region of the connecting piece preferably corresponds to the respective inner bore diameter of the bordering or adjacent inner ring, so that contact points are defined between the connecting piece and each respective inner ring. At least one curved, or more preferably ring-shaped, fixing element is preferably utilized to fix at least one inner ring relative to the connecting piece in the radial direction. The fixing element is preferably disposed at the contact point between the connecting piece and the respective inner ring. More preferably, the fixing element at least partially overlaps the connecting piece and the respective inner ring in the axial direction of the bearing assembly. Fixing elements may be disposed at each contact point of an inner ring and the connecting piece.

In such a representative, non-limiting bearing assembly, movement or displacement of the connecting piece in the radial direction, which has been a problem of known bearing assemblies, is prevented by the fixing element(s). The connecting piece is held in position by the fixing element or fixing elements, so that, for example, a wheel axle or axle spindle can be easily inserted when the present bearing assembly is utilized as a wheel bearing. In addition, such a bearing assembly offers the possibility of being manufactured relatively inexpensively in certain applications of the present teachings.

The one or more fixing elements is/are preferably disposed radially outward of the contact points defined by the respective inner rings and the connecting piece. In such an embodiment, the fixing element also may be manufactured in a relatively simple way. Moreover, it is not necessary to alter the shape of the inner bores of the inner rings and the connecting piece. That is, the inner bores can be manufactured with smooth, continuous inner surfaces. The loading capacity of the bearing assembly is thus not impaired by requiring a section or segment of the inner ring(s) or connecting piece to be made thinner in order to accommodate a fastening or fixing element on the inside surface of the bearing assembly, as is the case with certain known bearing assemblies.

In addition or in the alternative, the connecting piece and the fixing elements may be constructed such that axial movement of the fixing elements is limited to a small range or is prevented, so that each fixing element continuously overlaps the connecting piece and corresponding inner ring during operation. In this embodiment, the fixing elements can be prevented from moving or displacing too far in the axial direction from their home positions, which excessive axial shifting would eliminate or significantly diminish the radial-fixing effect of the fixing elements. This would take place if a fixing element no longer overlaps with the inner ring associated therewith or with the connecting piece. It is not absolutely necessary that the fixing elements are completely or immovably fixed in the axial direction. Relatively small movements in the axial direction are not critical, as long as the fixing element continues to at least partially overlap the connecting piece and the associated inner ring.

In addition or in the alternative, the connecting piece may include one or more retaining elements that is/are formed so as to limit the amount of axial movement of the fixing elements or to entirely prevent axial movement of the fixing elements. In this case, the retaining elements can prevent a disadvantageous excessive axial movement of the fixing elements.

In addition or in the alternative, the connecting piece may have two radially-extending projections or “cantilever arms” and each of the fixing elements may have at least one additional radially-extending cantilever arm. The cantilever arms are respectively disposed relative to each other in a manner that prevents axial movement of the fixing elements towards the connecting piece or at least restricts an amount of axial movement that would eliminate the overlap of the connecting piece and the respective inner ring. In a preferred embodiment, as soon as the respective cantilever arms of the connecting piece and the fixing element come into contact with each other, further movement of the respective fixing element in the axial direction is prevented. It is recommended that the spacing of the cantilever arms relative to the respective edge of the connecting piece is smaller than the axial length of the respective fixing element, so that the overlap of the fixing element with the respective inner ring is always maintained.

The term ‘cantilever arm’ as utilized herein to identify a structural feature associated with the connecting piece, fixing element and/or bearing cage may be replaced or substituted, e.g., with the term ‘projection’, ‘protrusion’, ‘flange’, ‘shoulder’, ‘stop’, etc., as all such structural features may be used interchangeably in the present teachings to perform the function of preventing or limiting axial shifting of the respective components.

The term ‘connecting piece’ may also be replaced or substituted with the term ‘sleeve’, ‘journal’, ‘spacer’, ‘spacer sleeve’, etc. The connecting piece preferably serves, in part, to define an axial separation or spacing between two inner rings and to provide a hollow cavity for receiving, e.g., an axle. The connecting piece also preferably includes at least one structural feature utilized in preventing or restricting movement of the connecting piece and the inner ring(s) in the axial direction of the bearing assembly.

The term ‘fixing element’ may also be replaced or substituted with the term ‘fastener’, ‘retainer’, ‘bracket’, ‘holding ring’, ‘retaining ring’, etc. The fixing element serves, in part, to maintain the relative positions of the connecting piece and the inner ring(s) in the radial direction of the bearing assembly. In addition, the fixing element optionally includes at least one structural feature utilized in preventing or restricting relative movement of the connecting piece and the inner ring(s) in the axial direction of the bearing assembly.

The terms ‘inner ring’ and ‘outer ring’ may also be replaced or substituted with the terms ‘inner race’ and ‘outer race’, respectively.

In accordance with another aspect of the present teachings, one or more of the bearings is embodied as a roller bearing and preferably includes one or more roller bearing elements or bodies, which is/are preferably disposed between the inner ring of the bearing and an outer ring of the bearing.

In accordance with another aspect of the present teachings, at least one of the fixing elements preferably has a cantilever arm disposed on the side facing the roller bearing(s) of the associated or adjacent bearing. The cantilever arm is preferably formed so as to prevent the fixing element from contacting the roller bodies of the corresponding roller bearing. If the fixing element were to contact one or more moving roller bodies of the roller bearing during operation, it could lead to damage and thus should be prevented. One design possibility entails extending one or more of the cantilever arm(s) so as to be high enough that it/they will contact an outer ring of the respective roller bearing before contact with the roller bodies takes place. In this case, a migration of the fixing element(s) into the roller bearing(s) during operation is avoided.

In addition or in the alternative, each roller bearing preferably comprises at least one cage. In this case, the cantilever arm of the respective corresponding fixing element is preferably formed such that an axial displacement of the fixing element towards or into the roller body is prevented by contact between the cage and the cantilever arm. In this case, the contact of the fixing element with the roller bodies can be prevented in a simple way, because as soon as one of the fixing elements comes into contact with the corresponding cage, a further penetration into the roller bearing is prevented.

In addition or in the alternative, the one or more fixing elements may be embodied as sheet metal rings preferably having a U-shaped profile in radial cross section. Such structures can be manufactured particularly simply and cost-effectively. In this embodiment, the cantilever arms of the fixing elements may be formed by the perpendicularly-extending flanks or projections or shoulders of the sheet metal ring and preferably serve to ensure that the connecting piece does not shift too far in the axial direction relative to the inner ring(s).

In another aspect of the present teachings, the connecting piece and the fixing element(s) may be formed such that axial movement of the fixing elements relative to the connecting piece and the inner rings is prevented. In this case, no movement clearance is provided to the fixing elements, so that they are fixed relative to the inner rings and the connecting ring. In such an embodiment, the connecting piece preferably has at least two recesses facing the respective fixing elements and each fixing element has at least one radially-inward-extending projection that engages with the corresponding recess such that movement of the fixing element relative to the connecting piece in the axial direction is prevented. Such an embodiment is also manufacturable at a relatively low cost.

The recesses may optionally be annular groove-shaped and the projections may be directed radially inward and extend partially or completely around the circumference of the fixing element(s). In this radially-symmetric embodiment, the mounting of the fixing elements can be particularly simple, because the mounting position is arbitrary relative to the radial orientation of the respective components.

In addition or in the alternative, a bearing assembly according to the present teachings may be a component of a wheel bearing, e.g., for usage in truck applications.

Further advantages and embodiments of the invention are derivable from the following description of exemplary embodiments together with the appended drawings.

### BRIEF DESCRIPTION OF THE DRAWINGS

FIG. 1 shows a preferred exemplary embodiment of the invention in schematic radial cross section.

FIG. 2 shows an alternative exemplary embodiment of the invention in an illustration analogous to FIG. 1.

FIG. 3 shows the exemplary embodiment of FIG. 2 with a dismantling helper.

### DETAILED DESCRIPTION OF THE PREFERRED EMBODIMENTS

Each of the additional features and teachings disclosed below may be utilized separately or in conjunction with other features and teachings to provide improved bearings and/or bearing assemblies, as well as methods for designing, constructing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

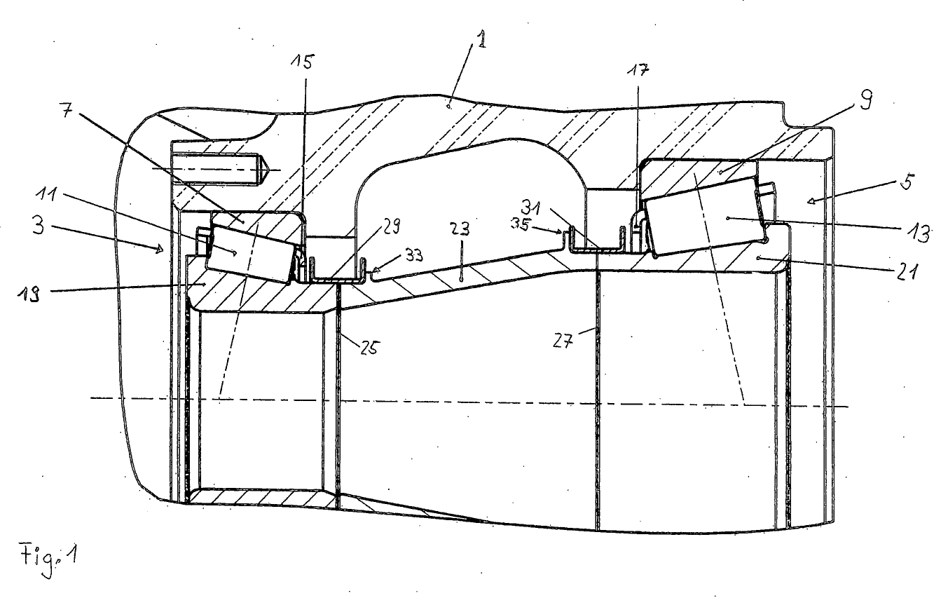

A first representative bearing assembly, which may be utilized as a wheel bearing in preferred embodiments, is illustrated in radial cross section in FIG. 1. Only components relevant for the description of the exemplary embodiment are depicted and described in the following. Other features may be utilized according to the known art and thus need not be explicitly described herein.

The representative wheel bearing of FIG. 1 comprises a support unit 1 for attachment of a rim on the wheel bearing. Two roller bearings 3 and 5 function to rotatably support the support unit or wheel hub 1 on a wheel axle or axle spindle, which is not depicted here. The roller bearings 3 and 5 each have an outer ring 7 and 9, respectively, roller bodies 11 and 13, respectively, cages 15 and 17, respectively, and inner rings 19 and 21, respectively. Although a single roller body 11, 13 is depicted for each roller bearing, a plurality of roller bodies may be used in preferred embodiments. Further, the two inner rings 19 and 21 preferably have differently-sized bore diameters, wherein the smaller inner ring 19 is disposed forward of the larger inner ring 21 with reference to the insertion direction of the wheel axle. That is, the wheel axle insertion direction is from right to left according to the illustration of FIG. 1.

The roller bearings 3 and 5 are arranged so as to be spaced in the axial direction. A connecting piece or spacer 23 is disposed between the roller bearings 3 and 5. The connecting piece 23 may be in contact with the inner rings 19 and 21 and thus determine the axial spacing of the roller bearings 3 and 5. However, one or more structures, such as a sealing element discussed below, may be interleaved between the connecting piece 23 and the respective inner rings 19, 21 in certain applications of the present teachings.

The connecting piece 23 is preferably sleeve-shaped, e.g., hollow, so that the wheel axle or axle spindle or other shaft can extend through it. Further, the connecting piece 23 is preferably substantially frustum- or conical-shaped, e.g., it may be tapered, such that the bore diameter of the connecting piece decreases along the axial direction of the connecting piece. The bore diameter of the connecting piece or spacer may decrease in a continuous manner, a discontinuous manner or a combination of the two.

At the circumferentially-extending contact points 25 and 27, the respective bore diameters substantially match the respective bore diameter of the bordering or adjacent inner ring 19 or 21, respectively. In certain applications of the present teachings, the bore diameters of the inner rings 19, 21 can be slightly smaller or larger than the adjacent diameters of the connecting piece 23. In such a design, the component having the smaller bore diameter should preferably be initially disposed further forward with reference to the insertion direction of the wheel axle. In this case, no points will result within the bore that would hinder the insertion of the wheel axle due to hitting or bumping against protrusions. The connecting piece 23 can also optionally include axially-extending segments having a constant inner bore diameter and/or a constant outer diameter near each contact point 25 and 27.

A circumferentially-extending fixing element 29, 31 is preferably disposed at each respective contact point 23 and 25. In one representative embodiment, the fixing element 29, 31 may be made, e.g., from a steel sheet, e.g., by bending, and preferably has a substantially U-shaped profile in radial cross section. Each of the fixing elements 29 and 31 overlap the inner ring 19, 21, respectively, associated with it, as well as the connecting piece 23, so that a radial displacement of the connecting piece 23 relative to the inner rings 19 and 21 is prevented. Consequently, the connecting piece 23 is held in the illustrated position so that the shaft or wheel axle is insertable therein without problems.

To ensure and maintain the connecting piece 23 remains fixed in the radial direction relative to the inner rings 19, 21, the fixing elements 29 and 31 are preferably not shiftable or displaceable from the respective axial positions shown in FIG. 1. However, a relatively small displacement of the fixing element 29, 31 in the axial direction is not critical, as along as a sufficiently large overlap of the respective fixing elements 29 and 31 with the respective inner rings 19, 21 and the connecting piece 23 is maintained. In case the fixing element 29, 31 axially displaces too far out of the overlap region on either side, the radial fixation of connecting piece 23 would no longer be ensured. To prevent such an undesirably large axial displacement of the fixing elements 29 and 31, the connecting piece 23 preferably has two cantilever arms or projections or stops 33 and 35 that correspond to the flanks or projections or stops of the U-shaped fixing elements 29 and 31 and stop (further) axial movement of the fixing elements 29 and 31 upon contact with the respective cantilever arms 33, 35. The spacing of the cantilever arms 33 and 35 from the respective ends of the connecting piece 23 is smaller or less than the axial length of the corresponding fixing element 29, 31, respectively, so that the fixing element 29, 31 can not leave or axially shift out of the overlap region with the respective inner ring 19, 21.

On the bearing side, the flank of the respective U-shaped fixing element 29, 31 is formed such that an overlap region with the respective cage 15, 17 results. A movement of the fixing elements 29, 31 towards the respective roller bearing 3, 5 is stopped upon contact of the flank of the respective fixing element 29, 31 with the respective cage 15, 17, so that the flank of the respective fixing element 29, 31 is prevented from contacting the respective roller body 11, 13.

In its axial home or middle position, the respective fixing elements 29, 31 must not be in direct contact with the respective cantilever arms 33, 35 or the respective cages 15, 17, which are merely intended to prevent the fixing elements 29 and 31 from shifting or sliding too far in the axial direction from the desired home or middle position.

In an alternative representative embodiment, the outer rings of the roller bearing may have cantilever arms that stop their movement towards the roller bearing body or bodies upon contact with the bearing-side flanks of the fixing elements.

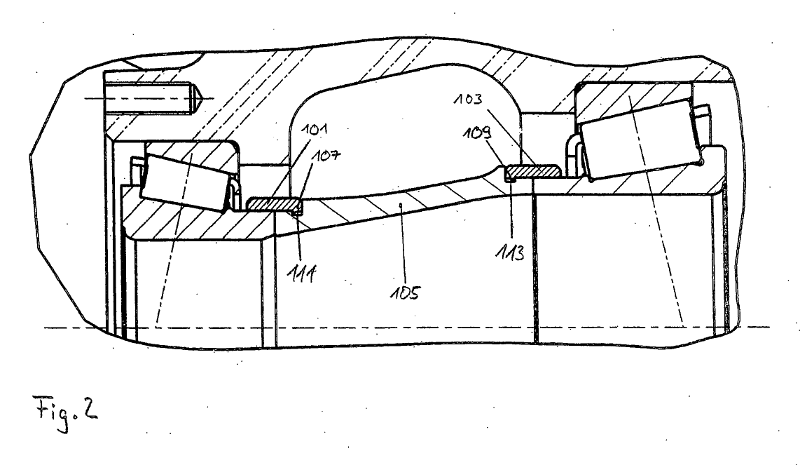

Another representative embodiment of the present teachings is illustrated in FIG. 2. It is constructed in a comparable way to the embodiment of FIG. 1 and generally differs only in the design of the fixing elements 101 and 103 and the features corresponding thereto. In this embodiment, the circumferentially-extending fixing elements 101 and 103 have circumferentially-extending, inwardly-directed projections 107 and 109, respectively, at each end facing toward the connecting piece 105. The connecting piece 105 has corresponding annular groove-shaped recesses 111 and 113, respectively. The projections 107, 109, respectively, engage with the recesses 111, 113, respectively. The fixing elements 101 and 103 are thus fixed in the axial direction by this projection-recess engagement.

In the alternative, it is possible to provide the recesses in the inner rings and to arrange the respective fixing elements 101, 103 in reversed or inverted form, so that the respective projections 107, 109 engage accordingly with the respective recesses. Furthermore, it is possible to form the recesses and the corresponding projections so as to not extend completely around the circumference of the connecting piece 105 and the fixing elements 101, 103. For example, in another aspect of the present teachings, two recesses may be provided in the connecting piece on opposite sides such that the recesses only partially circumferentially extend in the radial direction. In this case, the projections on the fixing elements would then be formed to have the same dimensions as the recesses, so as to preferably snugly engage therein. In this embodiment, it is advantageous to provide recesses in the connecting piece 105 as well as in the inner rings. Then, each correspondingly-formed projection of the respective fixing element 101, 103 engages with the recesses. The fixing elements 101 and 103 may have, e.g., a bracket shape.

For the assembly of the wheel bearing, it is advantageous if the inner rings 19 and 21 also remain fixed or immovable relative to the connecting piece 23, 105 in the axial direction. For example, each fixing element can be designed to engage the connecting piece and the corresponding inner ring in a friction-fit, so that a clamping force is maintained in the axial direction after assembly of the fixing elements, which axial clamping force hinders or prevents the connecting piece and inner rings from moving relative to each other in the axial direction. In addition or in the alternative, an axial clamping force can be applied to the connecting piece and inner ring(s) before mounting of the fixing elements, e.g., by compressing the connecting piece and inner ring(s) together in the axial direction. In a further advantageous embodiment, rough surfaces can be provided on the outer surfaces of one or both of the inner rings and/or the connecting piece in the area of the overlap with the fixing elements in order to facilitate the friction fit with the fixing elements. The inner surface of the fixing elements may also be provided with a rough surface.

It can be advantageous to provide a sealing element, e.g., a rubber or synthetic material ring, at or in each contact point 25 and 27 between the connecting piece 23 and the inner rings 19 and 21, respectively. A sealing element can be utilized to seal the roller bearing elements relative to the inner bore portion for receiving the wheel axle, so that no moisture can penetrate into the roller bearing elements. In the alternative, the inner sides of the fixing elements can be coated with a sealing lacquer, so that a sealing effect results after mounting.

In each of the depicted embodiments, the fixing elements can be designed in an advantageous way, such that they have an additional cantilever arm that reaches up to the support unit 1 or the outer rings 7 and 9, respectively. In the case of the embodiment in FIG. 1, each one of the flanks of the U-shaped profile can be extended. A grease or lubrication chamber for the lubrication of the roller bearing results from this design and may be reduced in size as compared to known designs, because the area between the support unit 1 and the connecting piece 23 is physically separated from the respective areas of the roller bearings 11, 13. As a result, the amount of lubricant necessary for the entire bearing assembly may be significantly reduced using this design. The fixing elements 101 and 103 of the embodiment of FIG. 2 can be designed in a corresponding manner.

Due to the described construction of the bearing assembly, it is possible to make the front or terminal sides of the inner rings 19 and 21, as well as the connecting piece 23, flat, because they are not required to perform an axial-fixing function due to the particular design. Consequently, the bearing clearance can be maintained as low as possible.

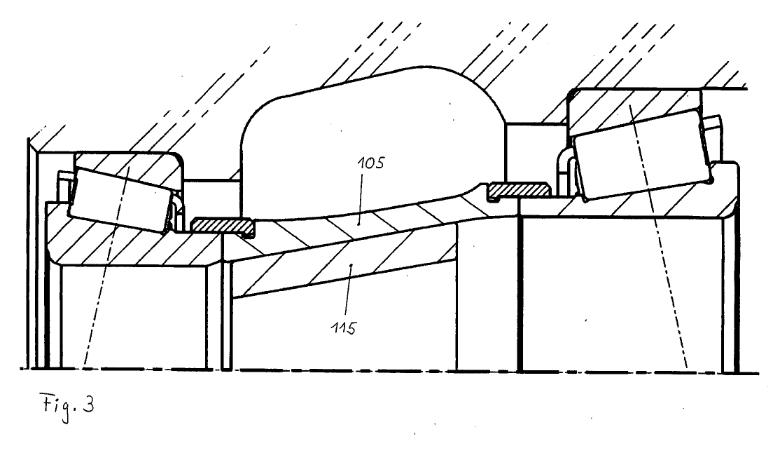

A dismantling of the wheel hub for maintenance or inspection purposes may be impeded by the friction-fit of the fixing elements. In order to facilitate maintenance or inspection operations, the embodiment of FIG. 2 is illustrated again in FIG. 3 with a dismantling helper 115 introduced inside of the connecting piece 105. The dismantling helper 115 also preferably has a frustum, conical or tapered shape and is sized to match the inner bore of the connecting piece 105. When the wheel axle is not inserted in the bearing assembly, the dismantling helper 115 can be introduced into the connecting piece 105 in a form-fit or location-fit manner. Axial forces can then be transmitted to the connecting piece 105 via the dismantling helper 115, whereby the press fit with the fixing elements can be loosened.

The described exemplary embodiments are not to be viewed as limiting with respect to the present teachings. A variety of alternative securing mechanisms that prevent an undesired shifting of the fixing elements in the axial direction can be readily designed by the skilled person in accordance with the present teachings without departing from the scope or spirit of the present invention.

### REFERENCE NUMBER LIST

| | |
|---|---|
| 1 | support unit |
| 3, 5 | roller bearing |
| 7, 9 | outer ring |
| 11, 13 | roller body |
| 15, 17 | cage |
| 19, 21 | inner ring |
| 23 | connecting piece |
| 25, 27 | contact point |
| 29, 31 | fixing element |
| 33, 35 | cantilever arm |
| 101, 103 | fixing element |
| 105 | connecting piece |
| 107, 109 | projection |
| 111, 113 | recess |

1. A bearing assembly comprising:
at least two axially-spaced bearings, each bearing comprising an inner ring, wherein the at least two inner rings have differently-sized bore diameters,
a sleeve-shaped connecting piece having a substantially frustum, conical or tapered shape disposed between and axially separating the two inner rings, wherein an inner diameter of the connecting piece at its respective axial end regions corresponds to the respective bore diameter of the adjacent inner ring so that first and second contact points are defined between the connecting piece and the respective inner rings, and
first and second curved fixing elements respectively extending adjacent the first and second contact points and fixing the respective inner rings relative to the connecting piece in a radial direction of the bearing assembly, each fixing element at least partially axially overlapping the connecting piece and the respective inner ring.

2. A bearing assembly according to claim 1, wherein the fixing elements are disposed radially outward of the respective contact points.

3. A bearing assembly according to claim 2, wherein the connecting piece and the fixing elements are configured such that movement of the fixing elements in the axial direction of the bearing assembly is restricted or prevented so that each fixing element always at least partially overlaps both the connecting piece and the respective inner ring.

4. A bearing assembly according to claim 3, wherein the connecting piece includes at least one retaining element configured to prevent or restrict movement of the fixing elements in the axial direction.

5. A bearing assembly according to claim 3, wherein the connecting piece comprises first and second radially-extending cantilever arms and each of the fixing elements comprises at least one radially-extending cantilever arm, wherein the cantilever arms are respectively configured and disposed relative to each other such that movement of the fixing elements in the axial direction is restricted or prevented so that each fixing element always at least partially overlaps both the connecting piece and the respective inner ring.

6. A bearing assembly according to claim 5, wherein the bearings are roller bearings.

7. A bearing assembly according to claim 6, wherein at least one of the fixing elements has a cantilever arm disposed on the side of the roller bearing, the cantilever arm being configured to prevent the fixing element from contacting at least one roller body disposed in the roller bearing.

8. A bearing assembly according to claim 7, wherein each roller bearing comprises at least one cage, wherein the cantilever arm of the respective corresponding fixing element is configured such that contact between the cage and the cantilever arm prevents axial displacement of the fixing element towards the roller body.

9. A bearing assembly according to claim 8, wherein each fixing element comprises a steel sheet ring having a substantially U-shaped profile in radial cross section.

10. A bearing assembly according to claim 2, wherein the connecting piece has at least two recesses and each fixing element has a radially-extending projection configured to engage with the corresponding recess, the engagement preventing axial movement of the fixing element relative to the connecting piece.

11. A bearing assembly according to claim 10, wherein the recesses are one of partially radially-extending grooves and annular grooves and the projections extend radially inward.

12. A bearing assembly according to claim 2, wherein a first overlap surface, which is defined by the overlap of a first fixing element and a first inner ring, and a second overlap surface, which is defined by the overlap of the first fixing element and the connecting piece, are configured such that a friction-fit between the fixing element and the inner ring and the connecting piece results.

13. A bearing assembly according to claim 12, wherein the inner ring includes at least one rough surface in the area of the first overlap surface and the connecting piece includes at least one rough surface in the area of the second overlap surface, the rough surfaces contributing to the friction-fit with the fixing element.

14. A bearing assembly comprising:
a first bearing comprising a first inner race having a first race bore diameter,
a second bearing comprising a second inner race having a second race bore diameter different from the first race bore diameter,
a hollow spacer disposed between the first and second inner races and at least substantially defining a spacing between the first and second inner races in an axial direction of the bearing assembly, the spacer having a first end adjacent to the first inner race and a second end adjacent to the second inner race, the first end having a first inner diameter at least substantially corresponding to the first race bore diameter and the second end having a second inner diameter at least substantially corresponding to the second race bore diameter, wherein a first junction is defined at a contact surface of the spacer and the first inner race and a second junction is defined at a contact surface of the spacer and the second inner race, and
at least one curved fastener disposed at least partially around and covering at least one of the first and second junctions, the fastener being configured to maintain at least one of the first and second inner races in position relative to the spacer in a radial direction of the bearing assembly.

15. A bearing assembly according to claim 14, wherein the spacer includes at least one retaining element configured such that movement of the fastener relative to the spacer in the axial direction is restricted or prevented so that the fastener always at least partially overlaps both the spacer and the adjacent inner race.

16. A bearing assembly according to claim 15, wherein the spacer comprises at least one radially-extending stop and the fastener comprises at least one radially-extending stop, wherein the stops are disposed relative to each other such that movement of the fastener relative to the spacer in the axial direction is restricted or prevented.

17. A bearing assembly according to claim 16, wherein each bearing further comprises an outer race and at least one roller body disposed between the inner and outer races.

18. A bearing assembly according to claim 17, wherein the fastener stop is configured to prevent the fastener from contacting the at least one roller body.

19. A bearing assembly according to claim 18, wherein each roller bearing comprises at least one cage, wherein the fastener stop is configured such that contact between the cage and the stop blocks axial displacement of the fixing element into contact with the roller body.

20. A bearing assembly according to claim 14, wherein the fastener comprises a steel sheet ring having a substantially U-shaped profile in radial cross section.

21. A bearing assembly according to claim 14, wherein the spacer includes at least one recess and each fixing element has a radially-extending projection configured to engage with the corresponding recess in the spacer, the engagement restricting or preventing axial movement of the fixing element relative to the connecting piece.

22. A bearing assembly according to claim 21, wherein the recess is one of a partially radially-extending groove and an annular groove and the projection extends radially inward.

23. A bearing assembly according to claim 14, wherein a first overlap surface, which is defined by the overlap of the fastener and a first inner race, and a second overlap surface, which is defined by the overlap of the fastener and the spacer, are configured such that a friction-fit between the fastener and the inner race and the spacer results.

24. A bearing assembly according to claim 23, wherein the inner race includes at least one rough surface in the area of the first overlap surface and the spacer includes at least one rough surface in the area of the second overlap surface, the rough surfaces contributing to the friction-fit.

25. A wheel bearing comprising the bearing assembly according to claim 14 and a wheel hub rotatably supported by the bearing assembly.
